(19) United States
(12) Patent Application Publication
(10) Pub. No.: US 2017/0210055 A1
(43) Pub. Date: Jul. 27, 2017

(54) THERMOSET SHAPE MEMORY POLY(UREA-URETHANE) WITH TUNABLE RESHAPING TEMPERATURE AND ITS APPLICATIONS

(71) Applicant: ZHEJIANG UNIVERSITY, HANGZHOU (CN)

(72) Inventors: TAO XIE, HANGZHOU (CN); JINGJUN WU, HANGZHOU (CN); QIAN ZHAO, HANGZHOU (CN); ZIZHENG FANG, HANGZHOU (CN)

(73) Assignee: ZHEJIANG UNIVERSITY

(21) Appl. No.: 15/415,427

(22) Filed: Jan. 25, 2017

(30) Foreign Application Priority Data
Jan. 26, 2016 (CN) 201610051681.3

(51) Int. Cl. B29C 61/00; B29C 35/02; B29C 61/06; B29C 43/00; C08G 18/83; C08G 18/48; C08G 18/73; C08G 18/32; C08G 18/24; B29C 35/16; B29C 55/00

(52) U.S. Cl. CPC B29C 61/003; B29C 35/16; B29C 35/02; B29C 61/06; B29C 43/003; B29C 55/005; C08G 18/48; C08G 18/73; C08G 18/3206; C08G 18/242; C08G 18/83; B29K 2075/02

(57) ABSTRACT

The disclosure provides a system of thermoset shape memory poly(urea-urethane) with permanent reshaping property and its application. The breakthrough of the present invention is that the reshaping temperature can be tuned in a wide range by incorporation of urea bonds into the polymer network. The permanent shape for shape memory poly(urea-urethane) can be repeatedly and cumulatively reshaped at certain temperature, largely facilitating the fabrication of complex structures.

### TECHNICAL FIELD

The present invention belongs to the field of functional material and, more particularly, relates to a type of shape memory polymer possessing permanent reshaping property.

### BACKGROUND

Shape memory polymers (SMPs), recovering from the temporary shape to the permanent shape at external stimulation, represent a new kind of stimuli-responsive materials, which are widely used in food processing, biomedical and other fields. Among them, heat shrinkage tubing in cable industry and heat shrinkage label in packaging industry had been extensive used, and the applications of the latter represented the highly automatization of packaging industry.

Originally, the most basic form of SMP was dual-shape memory effect (dual-SME), which can only occur between two different shapes. Generally, for a polymer to display dual-SME, it had to meet two requirements: a reversible thermal phase transition and a crosslinking network, while the former was used to fix its temporary shape. Afterward, two distinct thermal transitions in a crosslinked network were discovered and utilized to fix and recover two temporary shapes. This was called the triple-shape memory effect (triple-SME) (Lendlein, Proc. Natl. Acad. Sci. USA, 2006, 103, 18043). Later on, a single broad thermal phase transition in Nafion polymer was utilized to achieve tunable shape memory effect (tunable SME) (Xie, Nature, 2010, 464, 267). However, all above shape memory effects described so far were the one-way shape memory effect (1W-SME), which can only recover from the temporary shape to the permanent shape and the corresponding behaviors were not reversible. A system containing two crystalline phases in a crosslinked network was then obtained and exhibited two-way shape memory effect (2W-SME) (Lendlein, Adv. Mater., 2010, 22, 3424). The crystalline phase associated with the high phase transition temperature was used for the fixation of its temporary shape while the crystalline phase associated with the low phase transition temperature was used for the reversible shape change between the temporary shape and the original shape.

Nevertheless, all the above memory shaping polymers have limitations, which means some complex memory shaping polymers cannot be achieved. Generally, shape memory polymers were synthesized by molding. Restricted by the mold with high cost and the limitation of machining, the original shape (also termed permanent shape in this field) was associated with conventional simple shape. Furthermore, the shape memory polymers were crosslinked and lack of reprocessibility to achieve complex shape. This dilemma was solved by the invention (CN102037702A), in which an ester-bond bearing shape memory polymer was disclosed, wherein the ester bond was formed by reaction between unsaturated polyester with end double bonds and sulfhydryl group. The polymer can undertake reshaping under high temperature to be transformed into arbitrary complex original shape, while under low temperature (above phase transformation temperature), elastic reshaping may occur to achieve memory effects and the combination of both successfully achieved memory effects among complex shapes.

However, reshaping occurs when the corresponding reshaping temperature falls in the range of high temperature (100-160° C.). The high temperature is likely to cause the polymers to degrade, to destroy the crosslinking structures of the polymers, and to make the curing by external forces more difficult.

### SUMMARY OF THE INVENTION

The present invention discloses a system of thermoset shape memory poly(urea-urethane) with tunable permanent reshaping property and its application. In this disclosure, the permanent shape can be arbitrarily and cumulatively deformed, and in the meantime, exhibiting the shape memory behaviors. Furthermore, its simple preparation method and highly practical use facilitate the wide applications.

A system of thermoset shape memory poly(urea-urethane) based on the carbamate bond and the urea bond, characterized in that:

The crosslinked poly(urea-urethane) networks contain the carbamate bond and/or the urea bond.

The crosslinked poly(urea-urethane) networks contain the catalyst for the bond exchange reactions.

The crosslinked poly(urea-urethane) networks disclosed in this invention possess both a phase transition temperature and a reshaping temperature. The phase transition temperature, associated with the shape memory effect, can be a glass transition temperature, a melting temperature, or a liquid crystal clearing temperature. The conventional shape memory effect relies on the elastic deformation and phase transformation of crosslinked polymer. The polymer chain is activated above the phase transition temperature and entropy increased as a consequence of the deformation of the material. The infused energy could be temporarily stored under cooling and released once the chain's mobility regenerated as the heats implemented as a stimuli to trigger the shape recovery. In the present invention, the shape memory polymer comprises the carbamate bond and/or the urea bond, and bond exchange catalysts are added during the polymer synthesis process. The introduction of urea bond reduces the reshaping temperature (for example, in comparison to the reshaping temperature in CN105037702A), greatly increase the temperature adjustment range. The obtained polymers have stronger reshapeability.

The reshaping temperature is associated with the permanent reshaping effect. When heating above this temperature, the bond exchange reactions are activated, altering the topographical structure of the deformed polymer under external forces while remaining at its highest entropic state. The activation temperature of bond exchange reactions is thus defined as the reshaping temperature, at which the polymer experiences permanent network reconfiguration.

The crosslinked poly(urea-urethane) networks disclosed in this invention contains the carbamate bonds and the urea bonds as long as the catalyst to activate the bond exchange reaction. The incorporation of the urea bonds is meant to tune the reshaping temperature. By changing the bonds ratio of the carbamate and the urea bonds, the reshaping temperature can be tuned within a wide range, allowing for the wide use of this method.

The crosslinked poly(urea-urethane) networks are synthesized by the reaction of polyol or/and polyamine with isocyanate. The carbamate bonds are formed by the reaction of polyol and isocyanate while the urea bonds are formed by the reaction of amine and isocyanate. The crosslinked poly(urea-urethane) networks are polymerized by the following materials in a conventional method.

In specific embodiments, the isocyanates are chosen from diphenylmethane diisocyanate(MDI), 2,4-tolylene diisocyanate(TDI), hexamethylene diisocyanate(HDI), 1,5-naphthylene diisocyanate(NDI), xylene diisocyanate(XDI), triphenylmethane -triisocyanate, polyHDI, polyMDI, and polyTDI or a combination thereof.

The polyols can be chosen from polyester polyols, polyether polyols, and (C₂-C₄₅) polyols.

In specific embodiments, the polyester polyols are chosen from poly(caprolactone glycol), poly(ethylene glycol adipate), poly(ethylene propylene adipateglycol), poly(ethylene-diglycol adipate glycol), poly(ethylene-1, 4-buthylene adipateglycol), poly-1, 4-butylene adipate glycol, or a combination thereof. The molecular of the polyester polyols can be varied from 200-20000.

In specific embodiments, the polyether polyols are chosen from polyether diols. Preferably, the polyether diols are chosen from polyethylene oxide glycol, polyoxypropylene glycol, polytetramethylene glycol, and tetrahydrofuranoxide propylene copolymer glycol.

Chain extenders and crosslinkers are selectively added into the composition to tune the mechanical properties of the crosslinked poly(urea-urethane) networks.

Chain extenders are mainly small molecular alcohol, amine and ethanolamine with two active hydrogens. Advantageously, chain extender can be chosen from 1,4-butanediol, ethylene glycol, diethylene glycol, 1,6-hexanediol, N,N′-Di-tert-butylethylenediamine (TBEA), small molecular polyether diol and polyester diol.

Chain crosslinkers are mainly small molecular alcohols and amines with more than two active hydrogens. Advantageously, chain crosslinker can be chosen from glycerol, trimethylolpropane (TMP), pentaerythrotol, monoethanolamine, diethanolamine, tris(2-hydroxyethyl)amine, ethylenediamine, 1,4-butanediamine, 4,4′-methylene bis(2-chloroaniline) (MOCA), diethyltoluenediamine (DETDA), DMTDA.

For the crosslinked networks synthesized without any amine moieties, only carbamate bonds within the network can exchange with each other above the reshaping temperature. The phase transition temperature can be tuned from −15 to 150° C. by adjusting the molecular structures. By adjusting the added amount of catalyst, the reshaping temperature can be tuned in the range of 90-150° C.

Advantageously, the reshaping temperature should be designed 5° C. higher than the phase transition temperature in order to separate the shape memory process and the reshaping process.

When the chain extender or crosslinker contains amine moieties, urea bonds are formed within the network as the reaction product of the amine and isocyanate. The activation energy for the urea bond exchange is much lower than that of carbamate bond. In this case, the temperature to activate the bond exchange reactions can be lowered down. The reshaping temperature can be lowered down to 45° C. by changing the bond ratio of the carbamate bonds to the urea bonds in the composition.

A catalyst should be added to the above-mentioned composition to induce the polymerization of polyols/polyamines and isocyanates as well as the bond exchange reactions.

The catalysts to form the poly(urea-urethane) crosslinking networks are grouped into two main categories: tertiary amine compounds (including the corresponding quaternary ammonium salt) and metallorganic compounds. The tertiary amine catalyst includes aliphatic amine, alicyclic amine, aromatic amine, alkylol amine and their quaternary ammonium salts. The metallorganic compounds includes the alkylate salts and carboxylate salts of tin, zinc, magnesium, cobalt, calcium, titanium and zirconium. Advantageously, organic tin is chosen to catalyze the polymerization of the poly(urea-urethane) networks. More advantageously, the catalyst is dibutyltin dilaurate (DBTDL) or stannous octoate. The mass fraction of the catalyst to form the crosslinking networks can be 0.05%-5%.

The catalysts to activate the bond exchange reactions are preferably chosen from salts of tin, zinc, magnesium, cobalt, calcium, titanium and zirconium. The catalyst may also be chosen from catalyst of organic nature, such as 1,5,7-triazabicyclo[4.4.0]dec-5-ene, benzyldimethylamide, benzyltrimethylammonium chloride. Advantageously, the catalyst is chosen from: 1,5,7-triazabicyclo[4.4.0]dec-5-ene (TBD), dibutyltin dilaurate (DBTDL), benzyldimethylamide and zinc acetylacetonate. The mass fraction of the catalyst to activate the bond exchange can be 0.05%-10%.

Two points are necessary to be emphasized here: for some polyols/polyamines and isocyanates with high reactivity, the catalyst is not a necessity in the composition; some of the catalyst for the network forming can also be the catalyst for the bond exchange, such as the metallorganic compounds.

In certain embodiments, dibutyltin dilaurate (DBTDL) was selected as the catalyst not only to form the crosslinking networks, but also to activate the bond exchange. The mass fraction of the catalyst in the composition can be 0.1%-1.5%.

The application approach of the shape memory polymers possessing bond exchange induced reshaping property is provided in this disclosure, comprising the following steps:

1. The synthesized polymer material (shape I) should be fixed at an arbitrary desired shape (shape II) above reshaping temperature with an external force applied.
2. The bond exchange within the material thus occurs given the temperature and force hold.
3. The new shape II is permanently fixed under cooling and now defined as the new original (permanent) shape.
4. The processed polymer is altered to a temporary shape (shape III) above the transformation temperature under an external force.
5. The temporary shape shall be fixed under cooling.
6. The polymer will recover to the permanent shape (shape II) obtained lastly when heated above the phase transition temperature.

Steps 1-3 cover the reshaping process. The reshaping effect can be repeated and the original shapes can be arbitrarily and cumulatively deformed. That is to say, the original shape can be deformed into any complex new original shape when heated higher than reshaping temperature and loaded. This new original shape is permanent and can meet the requirement for different situations. The original shape of the crosslinked poly(urea-urethane) can be transformed into a new original shape through manipulation such as stretch, compression, and twist; or hot pressed in a new mold after ground into particles or powders. The reshaping temperature can be lowered down to 45° C. by adjusting the network composition thus broaden the practical application. A benefit of the reshaping process disclosed here is that particles of different crosslinked poly(urea-urethane) can be mixed in a mold and hot pressed into a homogeneous material thus tuning the reshaping temperature and other thermal or mechanical properties.

Steps 4-6 cover the shape memory effect. At a temperature higher than the phase transition temperature but lower than the reshaping temperature, the dynamic bonds exchange is non-activated and any deformation should lead to only chain conformation change. Cooling down below the phase transition temperature results in the fixation of the temporary shape, which can be recovered upon reheating.

Compared with some existing technologies, the benefits of this disclosure are:

(1) The reshaping temperature can be tuned in a wide range, facilitating the application for various requirements;

(2) In this system, the feature of simple application methods is facilitated for the mass production industrialization.

### BRIEF DESCRIPTION OF THE DRAWINGS

The following drawings are provided to form the specification and are included to further demonstrate certain embodiments or various aspects of the disclosure. The description and the accompanying drawings are used for a certain specific example.

FIG. 1. The Dynamic Mechanical Analysis (DMA) showing shape memory cycles and plasticity cycles of Example 1.

FIG. 2. The Dynamic Mechanical Analysis (DMA) showing shape memory cycles and plasticity cycles of Example 2.

FIG. 3. The shape memory cycles and plasticity cycles of Example 3.

FIG. 4. Demonstration of complex shape manipulation of Example 1.

FIG. 5. Demonstration of reprocessing and the shape memory properties of Example 2 and Example 3.

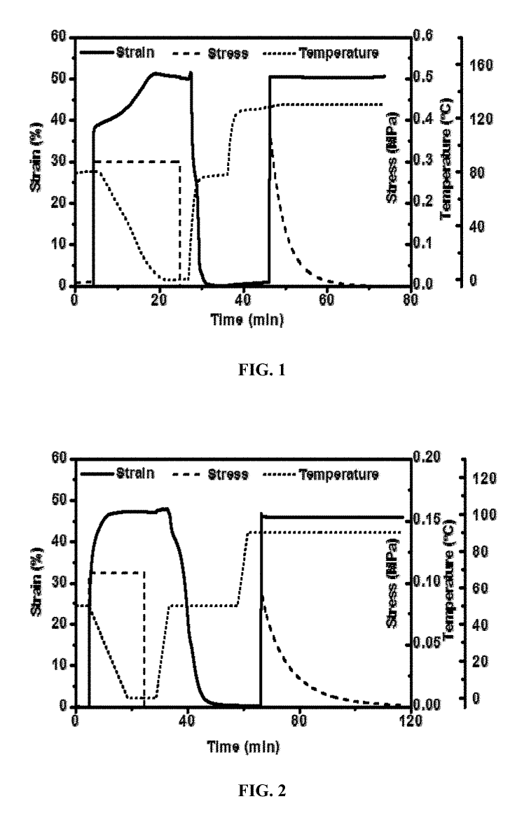

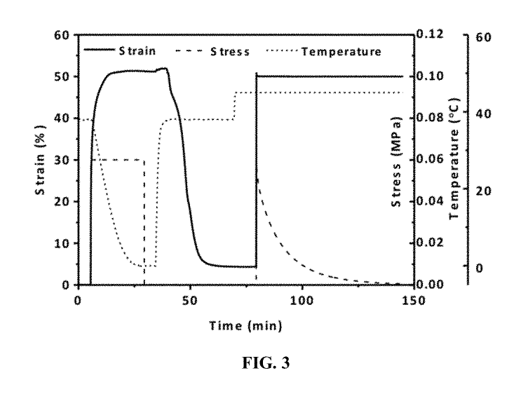

### DETAILED DESCRIPTION OF THE EMBODIMENTS

The following examples presented herein are intended to illustrate the disclosure. However, the scope is not limited to the following embodiment of the disclosure and it should be recognized that numerous variations and modifications may be made while remaining within the scope of the disclosure.

### (a) Materials and Synthesis.

### Example 1. Shape Memory Polyurethane

Materials:

Poly(ethylene glycol) diol (PEG) (Mₙ=8,000 g mol⁻¹) was obtained from Sigma-Aldrich with Formula (1a):

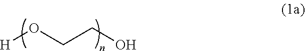

Hexamethylene diisocyanate (HDI) was purchased from Aladdin with Formula (1b):

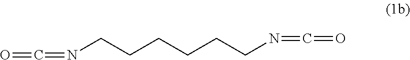 [SMILES: O=C=NCCCCCCN=C=O]

Glycerin was obtained from Aladdin with Formula (1c):

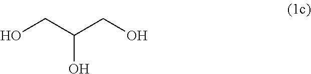

Ditin butyl dilaurate (DBTDL, as the catalyst) was purchased from Aladdin with Formula (1d):

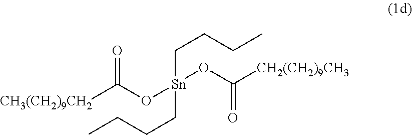

Polymer network synthesis: PEG was dehydrated in a vacuum drying oven for 4 hours at 100° C. prior to use. In a typical experiment, 0.75 mmol of PEG was weighted into a glass bottle and dissolved in butyl acetate at 60° C. Afterwards, 0.6 mmol of glycerin, 1.65 mmol of HDI, and the catalyst DBTDL (1 wt %) were added into the bottle and stirred for several minutes. After mixing homogenously, the mixture was poured into an aluminum pan and curing was conducted thermally at 60° C. for 4 hours. Finally, the cured sample was vacuum-dried at 100° C. overnight and demolded.

### Example 2. Shape Memory Poly(Urea-Urethane)

Material:

Poly(ethylene glycol) diol (PEG) (Mₙ=3,350 g mol⁻¹) was obtained from Sigma-Aldrich.

Hexamethylene diisocyanate (HDI) was purchased from Aladdin.

Glycerin was obtained from Aladdin.

Ditin butyl dilaurate (DBTDL, as the catalyst) was purchased from Aladdin.

N,N′-Di-tert-butylethylenediamine (TBEA) was purchased from TCI with Formula (2a):

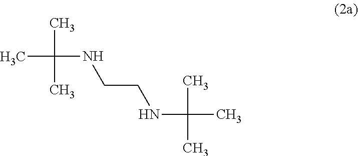

Polymer network synthesis: PEG was dehydrated in a vacuum drying oven for 4 hours at 100° C. prior to use. In a typical experiment, 0.35 mmol of PEG was weighted into a glass bottle and dissolved in butyl acetate at 60° C. Afterwards, 0.2 mmol of glycerin, 1.15 mmol of HDI, 0.5 mmol of TBEA, and the catalyst DBTDL (1 wt %) were added into the bottle and stirred for several minutes. After mixing homogenously, the mixture was poured into an aluminum pan and curing was conducted thermally at 60° C. for 4 hours. Finally, the cured sample was vacuum-dried at 100° C. overnight and demolded.

### Example 3. Shape Memory Poly(Urea-Urethane)

Material:

Poly(ethylene glycol) diol (PEG) (Mₙ=2,000 g mol⁻¹) was obtained from Sigma-Aldrich.

Hexamethylene diisocyanate (HDI) was purchased from Aladdin.

Glycerin was obtained from Aladdin.

Ditin butyl dilaurate (DBTDL, as the catalyst) was purchased from Aladdin.

N,N′-Di-tert-butylethylenediamine (TBEA) was purchased from TCI with Formula (2a):

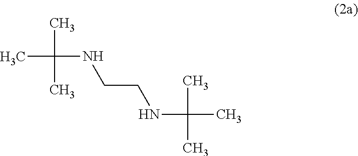

Polymer network synthesis: PEG was dehydrated in a vacuum drying oven for 4 hours at 100° C. prior to use. In a typical experiment, 0.35 mmol of PEG was weighted into a glass bottle and dissolved in butyl acetate at 60° C. Afterwards, 0.2 mmol of glycerin, 1.63 mmol of HDI, 0.98 mmol of TBEA, and the catalyst DBTDL (1 wt %) were added into the bottle and stirred for several minutes. After mixing homogenously, the mixture was poured into an aluminum pan and curing was conducted thermally at 60° C. for 4 hours. Finally, the cured sample was vacuum-dried at 100° C. overnight and demolded.

### (b) Characterization Methods.

Dynamic mechanical analysis (DMA) and differential scanning calorimetry analysis (DSC) experiments were performed to test the mechanical and thermal property, respectively. The choices of different molecular of PEG chain will tune the phase transition temperature in a wide range from room temperature to around 50° C. The phase transition temperature of the Example 1 is around 50° C. The phase transition temperature of the Example 2 is around 45° C. The phase transition temperature of the Example 3 is around 37° C.

In order to evaluate its shape memory and reshaping properties, samples were cut into rectangle shapes and the shape memory cycles and the stress relaxation cycles were performed by DMA experiments.

To test the reshaping property of the network, the samples were conducted in an iso-strain stress relaxation experiment, in which a sample was stretched to a 50% strain and the stress was monitored. Bond exchange reaction occurring during the reshaping process will result in the strain relaxation. The higher degree of strain relaxation, the better reshaping effect.

With carbamate bonds only, the samples (Example 1) need to be heated into 130° C. to ensure the full relaxation in a reasonable time. With low concentration of the hindered urea bond included (Example 2), the stress relaxation is accelerated. Only heated into 90° C., the similar full relaxation is achievable. Increasing the hindered urea bond (Example 3), the similar stress relaxation curves can be obtained only at around 45° C. Therefore, we can achieve a set of poly(urea-urethane) networks with tunable reshaping temperature by tuning the ratio of two kinds of dynamic reversible bonds, the urea bond and the carbamate bond.

### Example 1. Shape Memory Polyurethane

Shape memory cycles: The sample was heated to 80° C. and the shape was changed with an external force. The sample was then cooled down to 0° C. under load. After the load removal, the temporary shape was fixed. When the sample was reheated to 80° C., the temporary shape was recovered to its original shape.

Stress relaxation cycles: The sample was heated to 130° C. and the shape was changed with an external force. At this state, the bond exchange reaction was activated. Keeping temperature and force constant, the network topographic changed and the deformed shape was nonrecoverable without any internal force.

### Example 2. Shape Memory Poly(Urea-Urethane)

Shape memory cycles: The sample was heated to 50° C. and the shape was changed with an external force. The sample was then cooled down to 0° C. under load. After the load removal, the temporary shape was fixed. When the sample was reheated to 50° C., the temporary shape was recovered to its original shape.

Stress relaxation cycles: The sample was heated to 90° C. and the shape was changed with an external force. At this state, the bond exchange reaction was activated. Keeping temperature and force constant, the network topographic changed and the deformed shape was nonrecoverable without any internal force.

### Example 3. Shape Memory Poly(Urea-Urethane)

Shape memory cycles: The sample was heated to 38° C. and the shape was changed with an external force. The sample was then cooled down to 0° C. under load. After the load removal, the temporary shape was fixed. When the sample was reheated to 38° C., the temporary shape was recovered to its original shape.

Stress relaxation cycles: The sample was heated to 45° C. and the shape was changed with an external force. At this state, the bond exchange reaction was activated. Keeping temperature and force constant, the network topographic changed and the deformed shape was nonrecoverable without any internal force.

### (c) Manipulation.

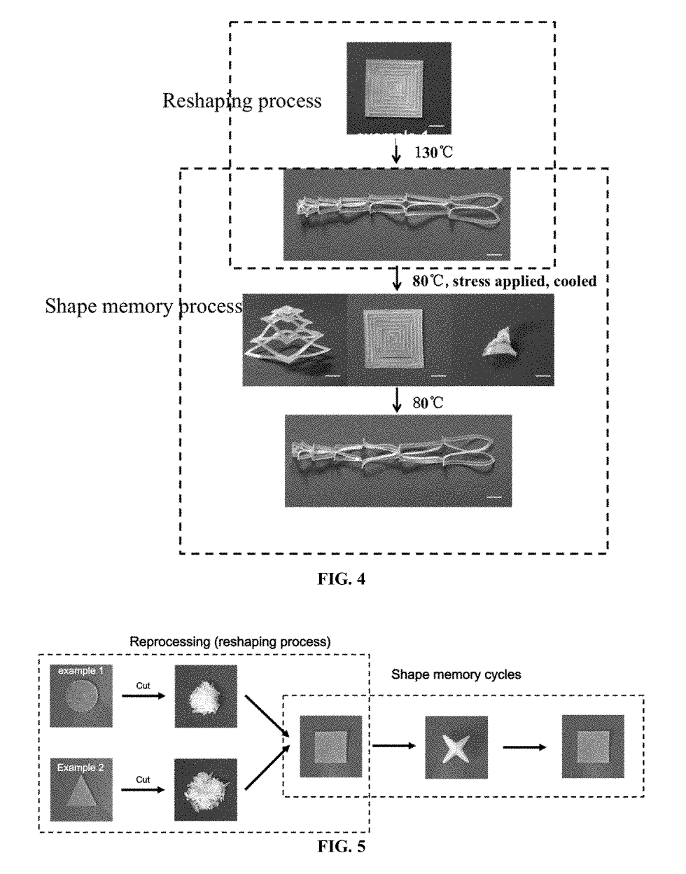

As FIG. 4 showed, the original shape is a square film with through-line patterns. The line patterns allow for shape manipulation using the Jianzhi technique. As such, the Example 1 can be deformed into a permanently elongated three-dimensional shape by simply applying a stretching force followed by annealing at 130° C. (higher than reshaping temperature). This permanent shape can be fixed into various temporary shapes at 0° C., including a pyramid, a twisted pyramid, and a flat film. All of these temporary shapes can fully recover to its permanent shape by reheating to 80° C. Importantly, this permanent shape can be further deformed back into the original flat square, which can also be fixed into temporary shapes.

As FIG. 5 showed, the original shape of Example 2 and Example 3 are circular and triangle sheet, respectively. They are cut into particles with similar sizes and charged into the same rectangle mold at 1:1 weight ratio. The temperature is 100° C., which is higher than both the reshaping temperature of the poly(urea-urethane) of Examples 2 and 3. The obtained rectangle sheet possesses one homogeneous network because of the bond exchange between the two poly(urea-urethane) network. The phase transition temperature and the reshaping temperature of the obtained network fall between those of example 2 and 3. So, this is an effective method to tune the reshaping temperature and the phase transition temperature by combination of two poly(urea-urethane) network.

It is to be appreciated that the foregoing description of the invention has been presented for purpose of illustrations and explanation and is not intended to limit the invention to the precise form of practice herein. It is to be appreciated therefore, that changes may be made by those who are skilled in the art without departing from the spirit of the present invention.

1. An application method of the shape memory poly(urea-urethane) possessing permanent reshaping property, the method comprising the steps of:
a) transforming synthesized crosslinked poly(urea-urethane) into an arbitrary desired shape above a reshaping temperature with an external force applied;
b) undertaking bond exchange within the material under the temperature and force;
c) permanently fixing a new shape under cooling and now defined as a new original shape;
d) altering processed polymer to a temporary shape above a phase transition temperature under an external force;
e) fixing the temporary shape under cooling;
f) recovering the polymer to the permanent shape obtained on reheating lastly;
wherein the steps a)-c) are reshaping processes, and can be implemented cumulatively at arbitrary lifetime of polymer in usage;
wherein the steps d)-f) are the shape memory process; and
wherein the crosslinked poly(urea-urethane) contains carbamate bonds and urea bonds in the network with bond exchange catalyst present.

2. The method of claim 1, wherein in the step a) of the reshaping process, the original shape of the crosslinked poly(urea-urethane) is transformed into a new original shape through manipulation such as stretch, compression, and twist; or hot pressed in a new mold after ground into particles or powders.

3. The method of claim 1, wherein the carbamate bonds are obtained by the reaction of polyols and isocyanate, and the urea bonds are obtained by the reaction of polyamines and isocyanate.

4. The method of claim 1, wherein the bond exchange catalyst includes 1,5,7-triazabicyclo[4.4.0]dec-5-ene, benzyldimethylamide, and salts of tin, zinc, magnesium, cobalt, calcium, titanium and zirconium.

5. The method of claim 1, wherein the amount of the bond exchange catalyst ranges from 0.05-5% by weight.

6. The method of claim 1, wherein the phase transition temperature should be glass transition temperature or melting temperature, ranging from −15-150° C.

7. The method of claim 1, wherein the permanent reshaping temperature should be at least 5° C. higher than the phase transition temperature.

8. The method of claim 1, wherein the reshaping temperature is higher than 45° C.
